(19) United States
(12) Patent Application Publication
(10) Pub. No.: US 2009/0254260 A1
(43) Pub. Date: Oct. 8, 2009

(54) FULL SPEED RANGE ADAPTIVE CRUISE CONTROL SYSTEM

(76) Inventors: Axel NIX, Birmingham, MI (US); James Kemp, Troy, MI (US)

Correspondence Address: MAGNA INTERNATIONAL, INC., 337 MAGNA DRIVE, AURORA, ON, L4G-7K1, CA

(21) Appl. No.: 12/419,495

(22) Filed: Apr. 7, 2009

Related U.S. Application Data
(60) Provisional application No. 61/042,924, filed on Apr. 7, 2008.

(51) Int. Cl. B60W 30/16; G01S 15/08; H04N 7/12

(52) U.S. Cl. 701/96; 367/106; 348/148; 348/E07.085

(57) ABSTRACT

In one aspect, the invention is directed to an adaptive cruise control system for a host vehicle, comprising a long-range sensor configured to determine a location of objects positioned ahead of the host vehicle, at least one short-range sensor configured to determine the location of objects in close proximity ahead of the host vehicle, and a controller configured to receive information from the long-range sensor and from the at least one short-range sensor and to control the speed of the host vehicle based at least in part thereon, wherein the controller is configured to operate the at least one short-range sensor in a plurality of operating modes, and to select a short-range sensor operating mode at least in part in response to the location of any objects detected by the long-range sensor.

This application claims the benefits of U.S. Provisional Application No. 61/042,924, filed Apr. 7, 2008.

### TECHNICAL FIELD

The present invention generally relates to an automotive cruise control system, and more particularly, to a full speed range cruise control system.

### BACKGROUND OF THE INVENTION

Traditional automotive cruise control systems maintain a user selected set-speed without any regard for traffic. In recent years adaptive cruise control (ACC) systems have entered the market, which utilize long-range sensing systems, e.g. 77 GHz radar systems or Lidar systems, to detect vehicles preceding the host vehicle. Based on detected preceding vehicles the adaptive cruise control systems adjusts the host vehicle speed to either the user selected set-speed or a safe following speed, whichever is lower. Ideally, a vehicle with engaged adaptive cruise control system can follow other vehicles in congested driving scenarios without a need for the driver to accelerate or decelerate manually.

Adaptive cruise control systems however require a minimum activation speed and automatically disengage when the host vehicle slows down below a deactivation speed. Given these limitations adaptive cruise control systems are generally limited to highway driving where the host vehicle does not come to a complete stop.

More recently follow-to-stop ACC systems, also called “full speed range ACC” or “Stop and Go ACC” have been suggested. The problem however is, that follow-to-stop ACC systems require much more accurate short-range sensing capability than traditional ACC systems. The accuracy requirement for follow-to-stop ACC exceeds the capability of traditional long-range sensing systems. Also, long-range sensors often utilize a narrow vertical opening angle to concentrate their transmitted energy on distant targets. Some vehicles, for example school buses or certain trailers, however have a rear end reaching high above the road. This can cause traditional long-range sensors to not detect the rear end of a vehicle but rather the rear axle of the preceding vehicle, leading to substantial measurement error. This problem and attempts to overcome it have been described in US200510159875, which is hereby incorporated by reference thereto.

Also, traditional cruise control systems have a relatively narrow field of view of only 12-16 degrees. While this is sufficient to detect distant vehicles in the same and neighboring lanes it is insufficient to e.g. detect a pedestrian walking up in front of the host vehicle, expecting it to come to a complete stop before reaching the pedestrian.

Automotive parking aid systems have long been using ultrasonic short-range sensors to help the driver estimate distance from other vehicles while parking. Known park assist systems however require relatively long time to detect objects, making them not suitable for follow-to-stop ACC systems which depend on quick reaction while the vehicle is still moving.

Therefore, in light of the problems associated with existing approaches, there is a need for improved follow-to-stop adaptive cruise control systems that eliminate the shortfalls associated with traditional ACC sensing systems.

### SUMMARY OF THE INVENTION

In one aspect, the invention is directed to an adaptive cruise control system for a host vehicle, comprising a long-range sensor configured to determine a location of objects positioned ahead of the host vehicle, at least one short-range sensor configured to determine the location of objects in close proximity ahead of the host vehicle, and a controller configured to receive information from the long-range sensor and from the at least one short-range sensor and to control the speed of the host vehicle based at least in part thereon, wherein the controller is configured to operate the at least one short-range sensor in a plurality of operating modes, and to select a short-range sensor operating mode at least in part in response to the location of any objects detected by the long-range sensor.

In another aspect, the invention is directed to an adaptive cruise control system for a host vehicle, comprising a long-range sensor configured to determine a location of vehicles located ahead of the host vehicle, at least one short-range sensor configured to determine the location of objects in close proximity ahead of the host vehicle, a controller configured to receive information from the long-range sensor and from the at least one short-range sensor and to control the speed of the host vehicle based thereon. The vertical opening angle of the at least one short-range sensor is larger than the vertical opening angle of the long-range sensor.

In another aspect, the invention is directed to an adaptive cruise control system for a host vehicle, comprising a long-range locating system configured to determine a location of vehicles located ahead of the host vehicle and at least one short-range sensor configured to determine the location of objects in close proximity ahead of the host vehicle. The short-range sensor is deactivated if the host vehicle exceeds a predetermined speed threshold.

In another aspect, the invention is directed to a method for locating objects in front of a host vehicle comprising:
synchronously transmitting ultrasonic pulses from a plurality of ultrasonic sensors, measuring the time of flight of ultrasonic reflections received by the ultrasonic sensors,
calculating the distance of objects based on the measured times of flight,
capturing an image of a scene in front of the vehicle, and
correlating the distance of objects detected by the ultrasonic sensors with objects extracted from the image of the scene in front of the vehicle.

In another aspect, the invention is directed to an adaptive cruise control system for a host vehicle, comprising a long-range locating system configured to determine a location of vehicles located ahead of the host vehicle and at least one short-range sensor configured to determine the location of objects in close proximity ahead of the host vehicle, wherein the short-range sensor is deactivated if the host vehicle exceeds a predetermined speed threshold.

### BRIEF DESCRIPTION OF THE DRAWINGS

The present invention will now be described by way of example only with reference to the attached drawings, in which:

FIG. 1 is a plan view of a host vehicle with an adaptive cruise control system in accordance with an embodiment of the present invention;

FIG. 2a is a simplified schematic diagram of a selected electrical components in the adaptive cruise control system shown in FIG. 1;

FIG. 2b is a more detailed schematic diagram of the selected electrical components shown in FIG. 2a;

FIGS. 3a and 3b illustrate the operation of ultrasonic sensors shown in FIG. 2b, in a first mode of operation;

FIGS. 4a and 4b illustrate the operation of the ultrasonic sensors shown in FIGS. 3a and 3b, in a second mode of operation;

FIGS. 5a and 5b illustrate the operation of the ultrasonic sensors shown in FIGS. 3a and 3b, in a third mode of operation;

FIG. 6 is an illustration of the relationship between several modes of operation of the ultrasonic sensors shown in FIG. 2b and the speed of the vehicle shown in FIG. 1;

FIG. 7a is an elevation view of the vehicle shown in FIG. 1 at a first distance to a preceding vehicle; and

FIG. 7b is an elevation view of the vehicle shown in FIG. 1 at a second, closer distance to a preceding vehicle.

### DETAILED DESCRIPTION OF THE INVENTION

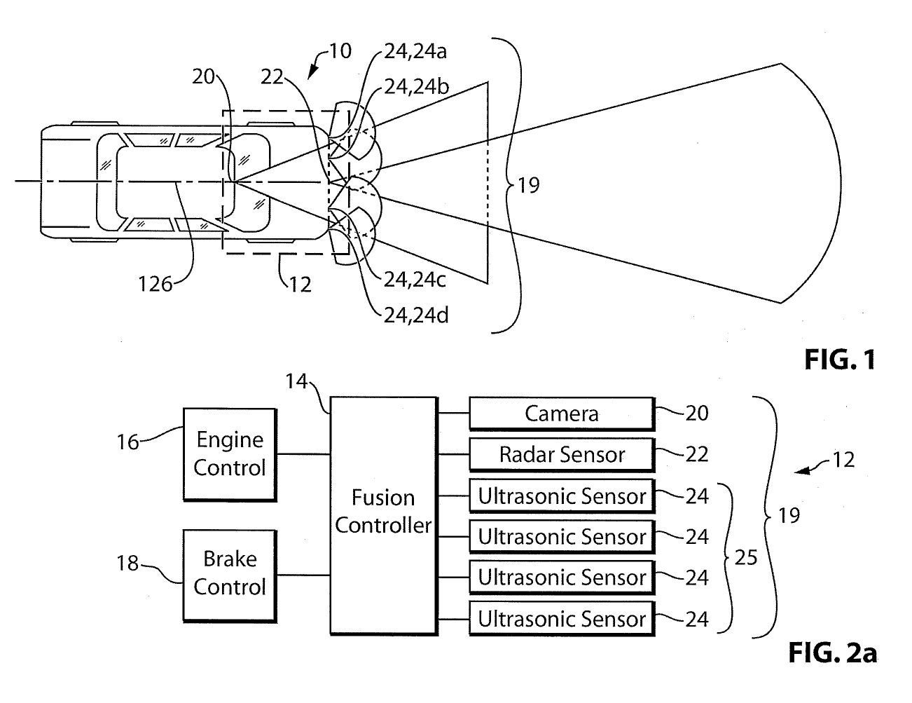

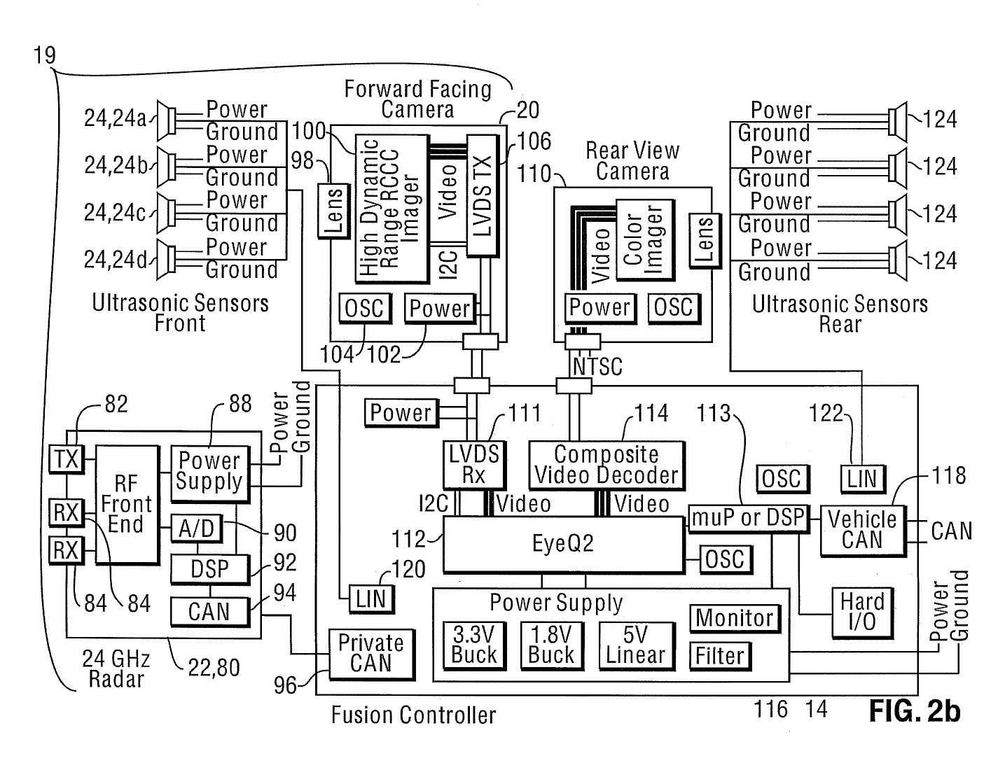

Reference is made to FIG. 1, which shows a host vehicle 10 with a full speed range adaptive cruise control system 12, which may also be referred to as a follow-to-stop adaptive cruise control system, in accordance with an embodiment of the present invention. Selected electrical components from the adaptive cruise control system 12 are shown in a simplified format in FIG. 2a. The adaptive cruise control system 12 includes a main controller 14 which may be referred to as a fusion controller, a fusion module or a fusion processing module, an engine controller 16, a brake controller 18, and a plurality of sensors 19, including a camera 20, a long-range sensor 22 and a plurality of short-range sensors 24 that are part of a short-range sensing system 25. The main controller 14 sends instructions to the engine controller 16 and to the brake controller 18 (ie. the main controller 14 is operatively connected to the engine and brake controllers 16 an 18) based on input from the camera 20, the long-range sensor 22 and short-range sensors 24, and based on input from in-cabin controls (not shown) permitting the vehicle driver to take such actions such as turning the adaptive cruise control system 12 on or off and to set a maximum speed for the host vehicle 10.

The long-range sensor 22 may be a radar sensor operating at 24 or 77 GHz, a Lidar sensor, or any other suitable distance measuring sensor that is suitable to detect vehicles and other objects in front of the host vehicle 10. A 24 GHz frequency modulated continuous wave (FMCW) sensor, shown at 80 in FIG. 2b, having an object detection range of about 120 m is an example of a suitable long-range sensor 22. Referring to FIG. 2b, the FMCW sensor 80 may include a transmitter 82 and one or more receivers 84, an RF signal processor and controller 86, a power supply 88 that is connected to a power source (not shown) and to ground (not shown), an a/d converter 90, a digital signal processor 92 and a CAN interface 94, which connects with a corresponding CAN interface 96 on the fusion controller 14.

The camera 20 may be any suitable type of camera, such as a monocular camera. The camera 20 may be a multi-functional, forward-facing camera employing image processing techniques to analyze a scene of the road in front of the host vehicle 10 in order to detect lane markings and other objects such as cars, trucks, buses, motorcycles, bicycles and pedestrians. Referring to FIG. 2b, the camera 20 may include a lens 98, an imager 100 such as a high dynamic range RCCC (Rate-Constrained Coder Control) imager, a power supply 102, an oscillator 104 and an LVDS (Low-voltage differential signal) transmitter 106 that communicates with a video interface 111 (ie. an LVDS receiver) on the fusion controller 14.

In the exemplary embodiment there are four short-range sensors, shown individually at 24a, 24b, 24c and 24d, provided in the short-range sensing system 25, however it will be appreciated that a greater or smaller number of short-range sensors 24 may be provided based on factors such as, for example, the width of the host vehicle 10 incorporating the cruise control system 12. The short-range sensors 24 may be any suitable type of sensors, such as piezo-electric ultrasonic sensors. Thus, the short-range sensors 24 may be referred to as ultrasonic sensors and the short-range sensing system 25 may be referred to as the ultrasonic sensing system 25. The ultrasonic sensors 24 may be part of a front park assist system with a range of about 2-3 meters. To avoid blind spots the ultrasonic sensing system may use 2 or more ultrasonic transmitter-and-sensing elements located in the front of the host vehicle 10, e.g. integrated into a front bumper.

The sensors 19 in the exemplary follow-to-stop adaptive cruise control system 12 may comprise internal data processing circuitry to track objects over time, in which case they may be referred to as ‘smart’ sensors. Such ‘smart’ sensors may communicate a processed list of objects including, if available, the objects' relative location to the host vehicle 10, estimated distance and angle of the objects relative to the host vehicle 10, object classification and other relevant information through a serial data bus for further processing. Alternatively, ‘dumb’ sensors may only include basic signal analysis processing and provide a snapshot of targets to a central processing module for further analysis. Different sensor types may be mixed, e.g. a ‘smart’ radar long-range sensor 22 may be used in combination with ‘dumb’ ultrasonic sensors 24.

Smart sensors 19 may receive object information from the other sensors 19 to refine their object tracking and classification. Information from all sensors 19 may be received by a central fusion processing module (ie. the main controller 14) which combines the information from the different sensors 19 to derive a more accurate map of objects around the host vehicle 10 than is available from each sensor 19 individually. Based on the object map around the host vehicle 10 the fusion module 14 may send acceleration and deceleration commands to other vehicle components, e.g. the engine controller 16 and the brake controller 18, through a serial data network. The fusion module 14 may be part of an existing powertrain or chassis control system. Additionally, the fusion controller 14 may receive and process signals from a rearview camera, shown at 110, which may be used as a backup assist camera.

The fusion module 14 may attribute different weights to information received from the various sensors 19 based on weighting factors. The radar sensor 22 may, for example, provide very accurate relative velocity information by measuring the Doppler shift in the radar echo of an object, while the camera 20 estimates relative velocity relatively less accurately, based on movement of the object's base point and size in the image viewed and analyzed by the camera 20. The weighting factors need not be constant but can be adjusted based on factors, such as, for example, distance of the object to the host vehicle 10, the speed of the host vehicle 10, weather and exterior lighting (day/night). More specifically, the ultrasonic short range distance sensing system 25 may, for example, only be used when the speed of the host vehicle 10 is below a threshold. The ultrasonic sensing system 25 may be turned off if the host vehicle 10 exceeds a first speed threshold speed Voff and turned on if the speed of the host vehicle 10 falls below a second speed threshold Von. The first speed threshold Voff may be higher than the second speed threshold Von, which means that, when the ultrasonic sensing system is on it may not go off until the host vehicle 10 rises above the threshold speed Voff, and once the ultrasonic sensing system 25 is off it may not go on until the host vehicle 10 drops below the second threshold speed Von. Alternatively, the first and second threshold speeds Von and Voff may be the same speed.

Referring to FIG. 2b, the fusion controller 14 includes a main control board 112, a processor 113, and other hardware such as the video interface 111 for communication with the forward-facing camera 20, a video interface 114 for communicating with the rearview camera 110, a power supply 116, the CAN interface 96 for communicating with the long-range sensor 22, a CAN interface 118 for communicating with other vehicle components, a LIN (local interconnect network) interface 120 for connecting to the short-range sensors 24 and another LIN interface 122 for connecting to short-range sensors 124 at the rear of the host vehicle 10, which may be used as part of a backup/parking assist system.

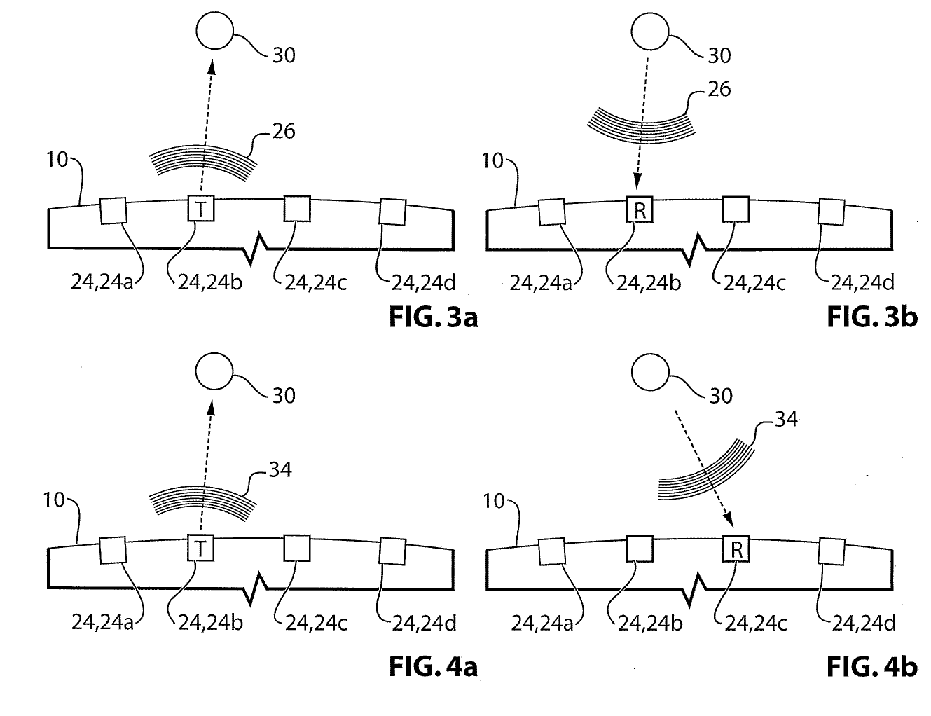

The ultrasonic short-range sensing system 25 may operate in different operating modes. In a first operating mode, which may be referred to as the A-A mode and which is illustrated in FIGS. 3a and 3b, a short ultrasonic pulse shown at 26 in FIG. 3a may be emitted by one of the two or more ultrasonic sensors 24, such as by sensor 24b. If an object is present in front of the host vehicle 10, the pulse 26 will be reflected off the object, which is shown at 30. The same sensor 24b may then be used to detect the reflected pulse 26. Based on the time of flight between emitting the pulse 26 and the detection of the reflected pulse 26, the distance of the closest object 30 from the sensor 24b may be derived.

In a second operating mode, illustrated in FIGS. 4a and 4b and which may be referred to as the A-B mode, one of the ultrasonic sensors, such as sensor 24b, may transmit an ultrasonic pulse shown at 34 (FIG. 4a) while one or more of the other sensors 24, such as sensors 24a, 24c and 24d, detects the ultrasonic reflection, also shown at 34 from the object 30 (FIG. 4b).

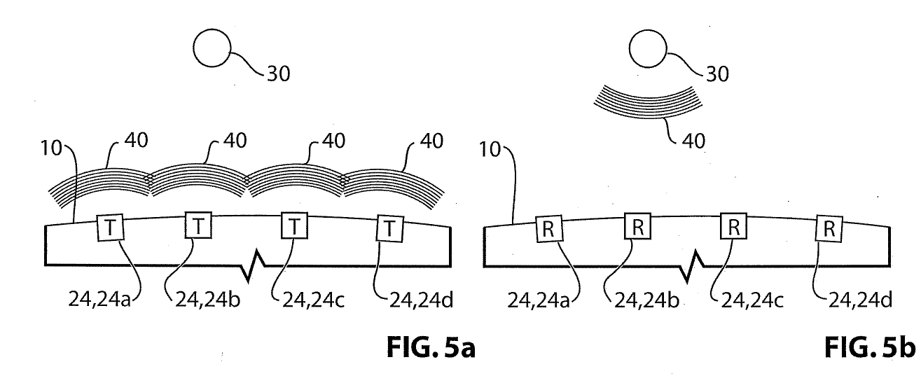

In a third mode, illustrated in FIGS. 5a and 5b, and which may be referred to as “synchronous mode” all ultrasonic sensors 24 may transmit ultrasonic pulses (shown at 40) simultaneously and then listen to reflections of the pulse 40 in parallel.

Each ultrasonic sensor 24 may operate at a frequency of about 51 kHz. To detect objects that are further away from the host vehicle a long ultrasonic pulse of about 20 cycles may be used. To detect object very close to the host vehicle a short ultrasonic pulse of about 8 cycles may be used.

Traditional ultrasonic parking sensors operate by alternating between short and long pulses and switch between A-A and A-B modes based on a fixed pattern. While the traditional operating mode is suitable to aid the driver at parking a vehicle the resulting overall system latency is relatively long (eg. up to approximately 500 msec).

Preferably when used in embodiments of the present invention, the ultrasonic sensor system 25 has a latency of around 50 msec. One way of providing a reduced latency, as compared with how the ultrasonic sensors 24 may be used in a park-assist system, is to eliminate short pulses (eg. the pulses of 8 cycles). Such pulses may be of assistance to detect objects in very close proximity to the host vehicle 10, but may be of relatively lower value during at least some stages of following a target vehicle to a full stop. As the host vehicle 10 slows down following a leading vehicle to a complete stop the distance of the leading vehicle may have already been determined by the long-range sensor 22 and the camera 20. The ultrasonic sensors 24 may be activated based on an activation speed threshold Von or based on information derived from the other sensors 19 that an object has entered or is about to enter the area covered by the ultrasonic sensors 24. In one embodiment, if the speed of the host vehicle 10 falls below a second, lower, speed threshold, short pulses (eg. of 8 cycles) may be used. While threshold speeds have been described to switch between different ultrasonic sensor operating modes more sophisticated approaches are possible. The fusion module 14 may, for example, based on information received from all sensors 19 over time create a map of objects around the host vehicle 10 and based on the host vehicle 10 approaching an object decide to utilize short ultrasonic pulses for added ultra-short-range sensing.

Another way of reducing ultrasonic sensing latency is to transmit ultrasonic pulses synchronously from two or more ultrasonic sensors 24 (as shown in FIG. 5a). By using synchronous transmission of ultrasonic pulses from several sensors the ability to triangulate the location of an object is lost, however. In a traditional park-assist application, triangulation may be used to distinguish between objects directly ahead of the host vehicle 10 and those slightly to the side of the host vehicle 10. Within the follow-to-stop ACC system 12 the camera 20 may be provided with accurate lateral resolution, so that the inability to triangulate during synchronous mode to obtain positional information on an object can be compensated for by deriving the positional information from the images input received by the camera 20.

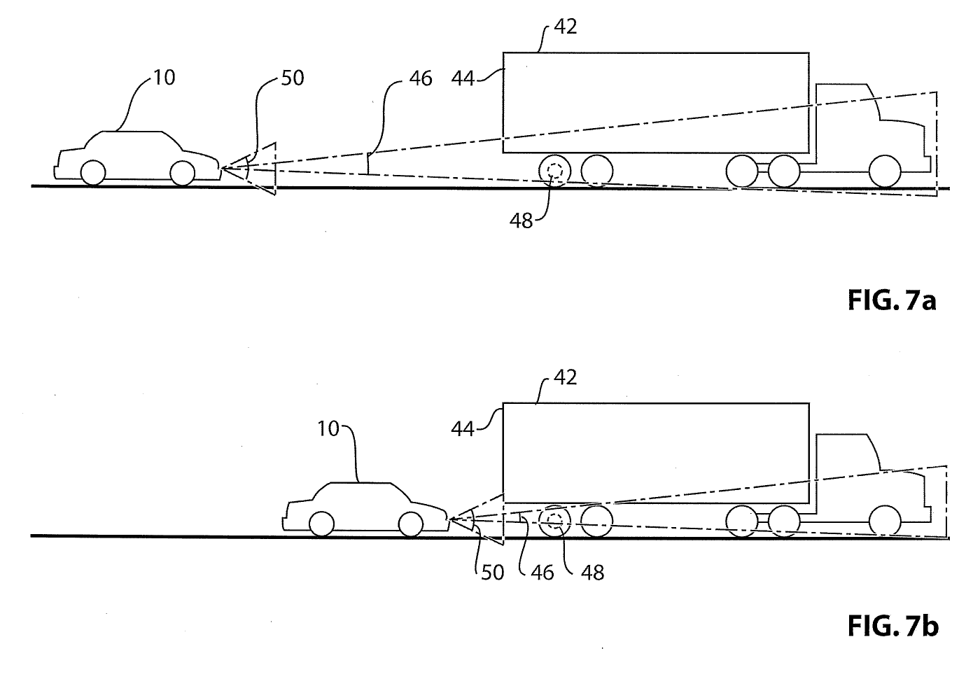

Some vehicles such as for example certain school buses or tractor-trailers, an example of which is shown at 42 in FIG. 7a, have a high-rising rear end 44 (ie. a rear end that is relatively elevated off the road surface). If the host vehicle follows a target vehicle 42 with a high-rising rear end 44, the long-range sensor 22, which may operate using a narrow vertical opening angle (shown at 46) of between 2 and 5 degrees may, depending on the mounting height of the long-range sensor 22 in the host vehicle 10 not detect the rear end 44 of the target vehicle 42. Instead the long-range sensor 22 may have an unobstructed view onto the rear axle shown at 48, which may be several meters in front of the rear end 44. The ultrasonic sensors 24 on the other hand may utilize a very wide vertical opening angle, shown at 50, that can detect objects up to about 1.8 m height at about 2.5 m distance and could therefore detect the rear end 44 of the preceding vehicle 42 when the host vehicle 10 is sufficiently close to the preceding vehicle 42 (as shown in FIG. 7b). For use in the follow-to-stop adaptive cruise control system 12, the distance information reported to the central fusion processing module 14 by the long-range sensor 22 and by the short-range sensors 24 may differ because the long-range sensor 22 may sense the rear axle 48, while the short-range sensors sense the actual rear end 44. In this case the host vehicle 10 may be brought to a complete stop based on object information from the camera 20 and the short-range sensors 24 while ignoring the information from the long-range sensor 22.

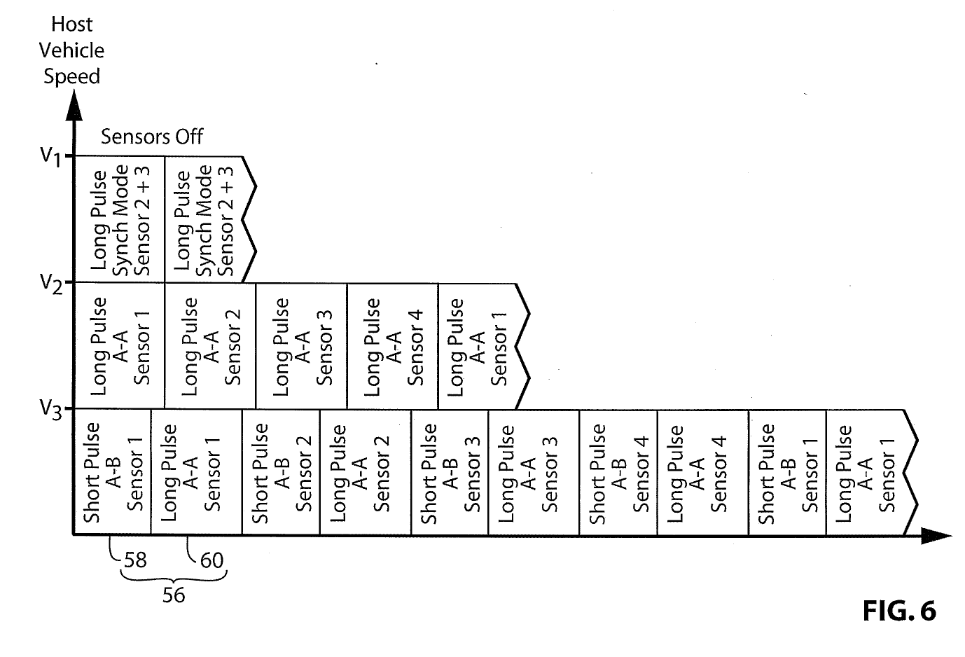

FIG. 6 shows a graph illustrating an exemplary method of operating the ultrasonic sensing system 25. When the host vehicle 10 (FIG. 1) is moving at a speed that is higher than a first threshold speed V1 (FIG. 6), which may be referred to as a slow speed, the ultrasonic sensors 24 (FIG. 1) are off, as they would not provide useful information to the main controller 14. When the host vehicle 10 (FIG. 1) is moving at a speed that is between the slow speed V1 and a lower, second threshold speed V2 (FIG. 6) (which may be referred to as a very-slow speed), the controller 14 (FIG. 2a) operates the ultrasonic sensors 24 in a short range operating mode wherein, two or more of the plurality of ultrasonic sensors 24 (FIG. 1) may operate together in ‘synchronous mode’, emitting long pulses and listening in parallel for reflections. Referring to FIG. 1, in embodiments wherein four sensors 24 are provided across the width of the host vehicle 10, the middle two sensors 24b and 24c (ie. the sensors 24b and 24c that are generally proximate the longitudinal centerline shown at 126 of the host vehicle 10) may be used for the operation of the sensor system 25 in the short range operating mode. When the host vehicle 10 (FIG. 1) is moving at a speed that is between the very-slow speed V2 and a third threshold speed V3 (FIG. 6) which may be referred to as a super-slow speed, the controller 14 may operate the ultrasonic sensors in a very-short range operating mode, wherein the plurality of ultrasonic sensors 24 (FIG. 1) operate sequentially in A-A mode each sensor 24 in sequence emitting a long pulse and listening for reflections of the emitted long pulse. For example, sensor 24a may first emit a long pulse and listen for reflections. Then sensor 24b emits a long pulse and listens for reflections, and so on. When operating in this way, at least some positional information is provided to the main controller 14, based on which sensor 24 senses the closest object. Referring to FIG. 1, in embodiments wherein four sensors 24 are provided across the width of the host vehicle 10, all or some of the sensors 24 may be used for the operation of the sensor system 25 in the very-short range operating mode. When the host vehicle 10 (FIG. 1) is moving at a speed that is lower than the super-slow threshold speed V3 (FIG. 6), the ultrasonic sensors 24 may be operated in a super-short range operating mode wherein the sensors 24 are operated sequentially as follows: Each sensor 24 in sequence is operated in a cycle 56 that includes a short pulse stage 58 and a long pulse stage 60. In the short pulse stage 58, the sensor 24 emits a short pulse and the other sensors 24 listen for a reflection (A-B mode). In the long pulse stage 60 the sensor 24 sends a long pulse and listens for the reflection (A-A mode). Thus, the first sensor 24a goes through the cycle 56 of operation; then the second sensor 24b goes through the cycle 56 of operation; then the third sensor 24c, and then the fourth sensor 24d. In each case where the sensors 24 are operated in sequence, the sequence of operation may be a repeating sequence of 24a, 24b, 24c and 24d, or it may be some other sequence.

While the present invention has been described with reference to exemplary embodiments, it will be readily apparent to those skilled in the art that the invention is not limited to the disclosed or illustrated embodiments but, on the contrary, is intended to cover numerous other modifications, substitutions, variations and broad equivalent arrangements that are included within the spirit and scope of the following claims.

What is claimed is:

1. An adaptive cruise control system for a host vehicle, comprising:
a long-range sensor configured to determine a location of objects positioned ahead of the host vehicle;
at least one short-range sensor configured to determine the location of objects in close proximity ahead of the host vehicle; and
a controller configured to receive information from the long-range sensor and from the at least one short-range sensor and to control the speed of the host vehicle based at least in part thereon, wherein the controller is configured to operate the at least one short-range sensor in a plurality of operating modes, and to select a short-range sensor operating mode at least in part in response to the location of any objects detected by the long-range sensor.

2. An adaptive cruise control system as claimed in claim 1, wherein at least one short-range sensor is an ultrasonic sensor.

3. An adaptive cruise control system as claimed in claim 1, wherein the plurality of operating modes includes a super-short range operating mode wherein the at least one ultrasonic sensor emits both short pulses and long pulses, and a short range operating mode wherein the ultrasonic sensor emits only long pulses.

4. An adaptive cruise control system as claimed in claim 1, wherein the operating mode is selected at least in part in response to the speed of the host vehicle.

5. An adaptive cruise control system as claimed in claim 1, wherein the at least one short-range sensor includes first, second, third and fourth ultrasonic sensors, and wherein the plurality of operating modes includes a super-short range operating mode used for speeds below a selected super-slow speed, and a very-short range operating mode used for speeds above the super-slow speed and less than a selected very slow speed,
wherein in the super-short range operating mode, each sensor sequentially is operated on a cycle having a short pulse stage in which a short pulse is emitted, and a long pulse stage in which a long pulse is emitted,
and wherein in the very-short range operating mode each ultrasonic sensor sequentially emits only long pulses.

6. An adaptive cruise control system as claimed in claim 5, wherein in the long pulse stage one sensor emits a long pulse and the other sensors are operated to sense for reflections of the long pulse.

7. An adaptive cruise control system as claimed in claim 5, wherein the plurality of operating modes includes a short range operating mode used for speeds above the very-slow speed and less than a selected slow speed, wherein in the short range operating mode selected sensors positioned proximate the longitudinal centerline of the host vehicle emit only long pulses.

8. An adaptive cruise control system as claimed in claim 5, wherein the plurality of operating modes includes a short range operating mode used for speeds above the very-slow speed and less than a selected slow speed, wherein in the short range operating mode selected sensors positioned proximate the longitudinal centerline of the host vehicle simultaneously emit only long pulses.

9. An adaptive cruise control system as claimed in claim 6, wherein for speeds above the slow speed, the ultrasonic sensors are turned off.

10. An adaptive cruise control system as claimed in claim 1, further comprising a camera positioned to receive video input from ahead of the host vehicle, wherein the controller is configured to selectively determine at least some positional information about an object in front of the host vehicle using the camera.

11. An adaptive cruise control system as claimed in claim 10, wherein the controller is configured to selectively determine at least some positional information about an object in front of the host vehicle using the video input from the camera based at least in part on information received by the controller from the long-range sensor.

12. An adaptive cruise control system as claimed in claim 10, wherein the controller is configured to selectively determine at least some positional information about an object in front of the host vehicle using the video input from the camera based at least in part on video input received by the controller from the camera.

13. An adaptive cruise control system for a host vehicle, comprising:
a long-range sensor configured to determine a location of vehicles located ahead of the host vehicle;
at least one short-range sensor configured to determine the location of objects in close proximity ahead of the host vehicle, wherein the vertical opening angle of the at least one short-range sensor is larger than the vertical opening angle of the long-range sensor; and
a controller configured to receive information from the long-range sensor and from the at least one short-range sensor and to control the speed of the host vehicle based thereon.

14. An adaptive cruise control system as claimed in claim 13, wherein at least one short-range sensor is an ultrasonic sensor.

15. An adaptive cruise control system as claimed in claim 13, further comprising a camera positioned to receive video input from ahead of the host vehicle, wherein the controller is configured to selectively determine at least some positional information about an object in front of the host vehicle using the camera.

16. An adaptive cruise control system as claimed in claim 13, wherein the controller is configured to selectively determine at least some positional information about an object in front of the host vehicle using the video input from the camera based at least in part on information received by the controller from the long-range sensor.

17. An adaptive cruise control system as claimed in claim 13, wherein the controller is configured to selectively determine at least some positional information about an object in front of the host vehicle using the video input from the camera based at least in part on video input received by the controller from the camera.

18. An adaptive cruise control system as claimed in claim 13, wherein the controller is configured to selectively determine at least some positional information about an object in front of the host vehicle preferentially using the video input from the camera and using information from the at least one short-range sensor, based at least in part on video input received by the controller from the camera.

19. A method for locating objects in front of a host vehicle comprising:
synchronously transmitting ultrasonic pulses from a plurality of ultrasonic sensors, measuring the time of flight of ultrasonic reflections received by the ultrasonic sensors,
calculating the distance of objects based on the measured times of flight,
capturing an image of a scene in front of the vehicle, and
correlating the distance of objects detected by the ultrasonic sensors with objects extracted from the image of the scene in front of the vehicle.
